(19) United States
(12) Patent Application Publication
(10) Pub. No.: US 2003/0151659 A1
(43) Pub. Date: Aug. 14, 2003

(54) Camera for generating a stereoscopic pair of images

(75) Inventors: Kiyoshi Kawano, Saitama-ken (JP); Toshio Masuda, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/358,884

(22) Filed: Feb. 6, 2003

(30) Foreign Application Priority Data
Feb. 13, 2002 (JP) 2002-035090

(51) Int. Cl. H04N 13/02

(52) U.S. Cl. 348/42; 348/49

(57) ABSTRACT

The digital camera is adapted to generates a stereoscopic pair of images from a first image taken from a first camera location and a second image taken from a second camera location. The digital camera includes an imaging device for capturing an image of the object to be taken, an optical system for forming an optical image of the object and a processor for controlling the digital camera. The processor determines a distance from the digital camera to the object, or object distance, from the position of a focusing lens of the optical system. The processor further calculates a distance for which the digital camera should be moved after the first image is taken to be located at the second camera location. The distance for which the digital camera should be moved is displayed on an LCD monitor to inform the user of the digital camera.

### BACKGROUND OF THE INVENTION

The present invention relates to a camera, and in particular, to a camera suitable for generating a stereoscopic pair of images.

A stereoscopic pair of images can be generated with a single camera by carrying out a first shoot for taking a first image of an object, then displacing the camera horizontally for an suitable distance, and then carrying out a second shoot for taking a second image of the same object.

In order to obtain a good stereoscopic effect from the pair of images taken as above, the camera should be displaced between the first and second shoots for an appropriate distance which depends on the distance from the digital camera to the object, or object distance. However, since the object distance may vary each time the stereoscopic pair of images are to be taken, and also since it is normally difficult for the user to visually estimate the correct object distance, the user cannot determine the suitable distance for displacing the camera and hence often fails to get images having good stereoscopic effects. Therefore, there is a need for a camera that can assists the user in displacing the camera for a suitable distance when a stereoscopic pair of images is to be taken.

### SUMMARY OF THE INVENTION

The present invention is directed to a camera that satisfy the need mentioned above.

According to an aspect of the invention, there is provided a camera for generating a stereoscopic pair of images of an object by carrying out a first shoot for taking the first image of the object, and then carrying out a second shoot for taking the second image of the same object after being laterally displaced.

The camera includes an object distance detector, a displacing distance determiner, and a display unit. The object distance detector detects the distance from the camera to the object to be taken, or the object distance, at the time of taking the first image.

The displacing distance determiner determines the distance for which the camera should be laterally displaced between the first and second shoots based on the object distance. The distance for camera displacement is determined within a range of 1/30 to 1/60 of the object distance, for example, so that a good stereoscopic effect can be obtained from the resulting stereoscopic pair of images.

The display unit displays a guide information including the distance determined as above. Thus, the user of the camera can know the suitable distance for which the camera should be displayed between the first and second shoots whenever a stereoscopic pair of images are to be taken.

The guide information displayed by the display unit may also include a mark that indicates the direction in which the camera should be displaced to prevent the user from moving the camera in a wrong direction.

Optionally, the object distance detector detects the object distance from the position of a focusing lens of an optical system provided to the camera to form an optical image of the object. In such a case, the camera may further include a memory for holding a lookup table that provides the relation between the focusing lens position and the object distance, and the object distance detector may determine the object distance from the focusing lens position by making reference to the lookup table.

Optionally, the display unit is also utilized to display an image currently captured by the camera for allowing framing of the images to be taken. This arrangement ensures that the user notices the displayed guide information before taking the second image.

Further optionally, a switch is provided to the camera which is to be operated to confirm that the user has seen the guide information, and the display unit terminates displaying the guide information when the switch is operated. This arrangement allows the user to avoid being annoyed by the guide information during framing the image to be taken by operating the switch.

According to another aspect of the invention, a digital camera for generating a stereoscopic pair of images that includes a first image taken from a first camera location and a second image taken from a second camera location laterally displaced from the first camera location is provided. The digital camera includes an imaging device that captures the first and second images of the object, and a display unit that displays the image currently captured by the imaging device to allow framing of the first and second images. The display unit further displays a guide information including the distance between the first and second camera locations.

In the digital camera arranged as above, the user of the camera finds the guide image whenever he/she looks at the display unit for framing the second image to be taken, and thereby can know the correct distance for moving the camera from the first camera location to the second camera location.

### BRIEF DESCRIPTION OF THE ACCOMPANYING DRAWINGS

FIG. 1 is a block diagram illustrating an electronic configuration of a digital camera according to an embodiment of the invention;

FIG. 2 illustrates a hierarchical structure of operating modes of the digital camera of FIG. 1;

FIGS. 3A through 3C are flow charts showing a process carried out in the digital camera of FIG. 1;

FIGS. 4A through 4J show exemplary images displayed on a LCD monitor of the digital camera of FIG. 1;

FIG. 5 schematically illustrates how a first stereo image is generated;

FIG. 6 schematically illustrates how a set of data of a stereoscopic image to be observed by parallel view method is generated; and

FIG. 7 schematically illustrates how a set of data of a stereoscopic image to be observed by cross view method is generated.

### DETAILED DESCRIPTION OF THE EMBODIMENTS

Hereinafter, an embodiment of the invention will be described with reference to the accompanying drawings.

FIG. 1 is a block diagram illustrating an electronic configuration of a digital camera according to the embodiment of the invention.

In the digital camera according to the present embodiment, a lens system 11 forms an optical image on a light receiving surface of a CCD 12 which is driven by a CCD driver 24. The pixels of the CCD 12 convert the optical image of the object into an analog electronic signal. The analog signal is sampled by a correlation double sampling circuit (CDS circuit) 13 and then converted into digital image signal by an A/D converter 14. Then, the digital image signal enters a microprocessor 15 which applies various processing to the image signal, such as color balancing and gamma correction, to generate digital data on the brightness and color of the image captured by the CCD 12.

The microprocessor stores the obtained digital image data into a memory such as a DRAM 16. The microprocessor 15 also saves, if required, the digital image data held in the DRAM 16 into a recording medium 26 via an interface 25. A memory card such as a compact flash (CF) card may be utilized as the recording medium 26.

The digital image data held in the DRAM 16 can be copied into a VRAM 17 to display the image on a monitor device such as an LCD monitor 22. The digital image data copied into the VRAM 17 is converted to an analog image signal by a D/A converter 18. Further, a video encoder 19 converts the analog image signal into a video signal and output it to and adder 20. The adder 20 mixes a video signal generated by an on-screen display (OSD) circuit 21 to the video signal from the video encoder 19 to superimpose characters, signs, graphic images, mask patterns, grid patterns and the like on the image captured by the CCD 12. The characters, signs and the like superimposed on the image as above may include various information on the camera such as shutter speed and f-numbers. The mixed video signal is sent to the LCD monitor 22 to display a moving image and/or a still image captured by the CCD 12.

The focusing of the lens system 11 is carried out by a focusing lens driving mechanism 23. The focusing lens driving mechanism 23 rotates a lead screw (not shown) by a pulse motor (not shown) and thereby drives a focusing lens of the lens system 11 along the optical axis thereof. The lens driving mechanism 23 is controlled by the microprocessor 15.

The microprocessor 15 is connected with a main switch 27, a mode selecting dial 28, a selecting switch 29, a determination switch 30, a release switch 31, and a photometry switch 32.

The main switch 27 is for changing the state of the digital camera 10 from a sleep mode to an ON mode or vice versa. The mode selecting dial 28 is for selecting the operating mode of the digital camera 10. In the digital camera 10 according to the present embodiment, a recording mode, a playback mode, and an edit mode can be selected by operating the mode selecting dial 28.

The recording mode has several sub-modes. When the recording mode is selected by the mode selecting dial 28, a menu for selecting the sub-mode will be displayed on the LCD monitor 22. The sub-mode can be selected by operating the selecting switch 29 and then pressing the determination switch 30 to confirm the selection.

The release switch 31 and the photometry switch 32 are configured such that the photometry switch 32 becomes ON by depressing a shutter button (not shown) halfway and the release switch 31 becomes ON when the shutter button is fully depressed. When the photometry switch 32 is ON, the digital camera 10 of the present embodiment performs photometry, and when the release switch is ON, the digital camera 10 carries out a shoot.

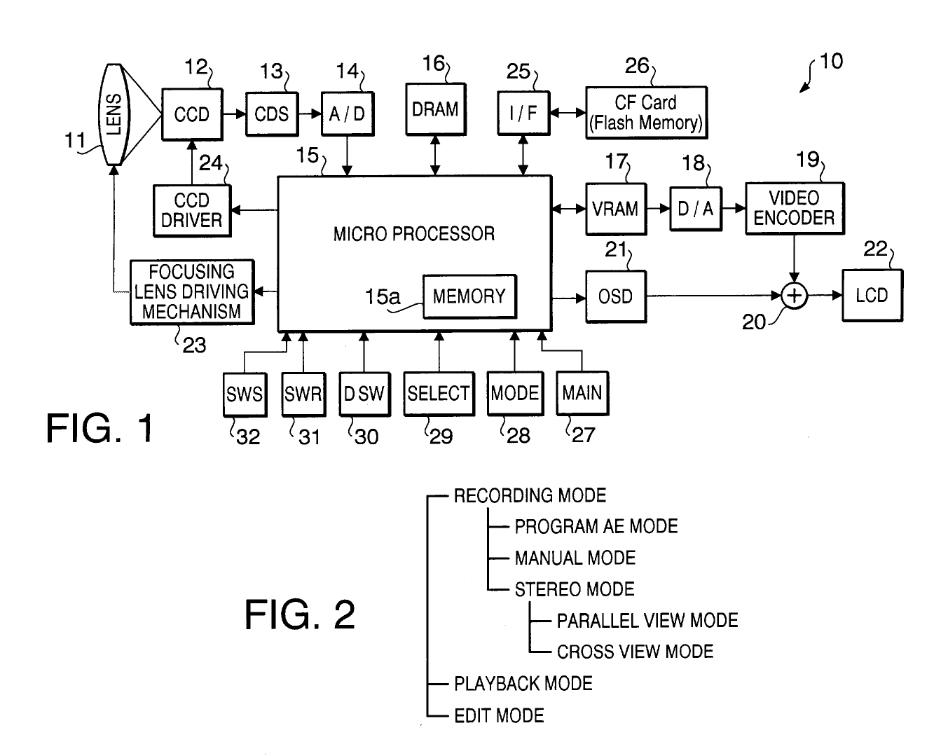

FIG. 2 illustrates a hierarchical structure of the operating modes of the digital camera 10 according to the embodiment. In the digital camera 10 according to the embodiment, one of the recording mode, the playback mode, and the edit mode can be selected by operating the mode selecting dial 28.

The recording mode includes several sub-modes such as program AE mode, manual mode, stereo mode, and the like. If the mode selecting dial 28 is adjusted to recording mode, the OSD circuit 21 generates a video signal to superimpose on the LCD monitor 22 one of the sub-modes of the recording mode. The sub-mode displayed on the LCD monitor 22 changes in sequence whenever the selecting switch 29 is pressed. The digital camera 10 begins to operate in the sub-mode currently displayed on the LCD monitor 22 if the determination switch 30 is pressed.

If the stereo mode is selected, the digital camera records two still images (which are taken one after another from two different locations so as to obtain a stereoscopic pair of images, i.e., a left image and a right image) in one frame such that the picture reproduced therefrom have one of the two still images at the left half and the other one at the right half.

The stereo mode has two sub-modes, i.e., parallel view mode and cross view mode. In the parallel view mode, the digital camera 10 records the stereoscopic pair of still images such that the left image becomes on the left half of the reproduced picture and the right image becomes on the right half. On the contrary, the stereoscopic pair of still images are recorded such that the left image becomes on the right half of the reproduced picture and the right image on the left half if the cross view method is selected. Note that, in the present embodiment, the still image obtained by the first shoot is defined as the left image and the still image obtained by the second shoot as the right image.

If the stereo mode is selected, the OSD circuit 21 generates signals for superimposing a menu on the LCD monitor 22 for selecting either the parallel view mode or the cross view mode. Selection can be carried out by operating the selecting switch 29 and then pressing the determination switch 30.

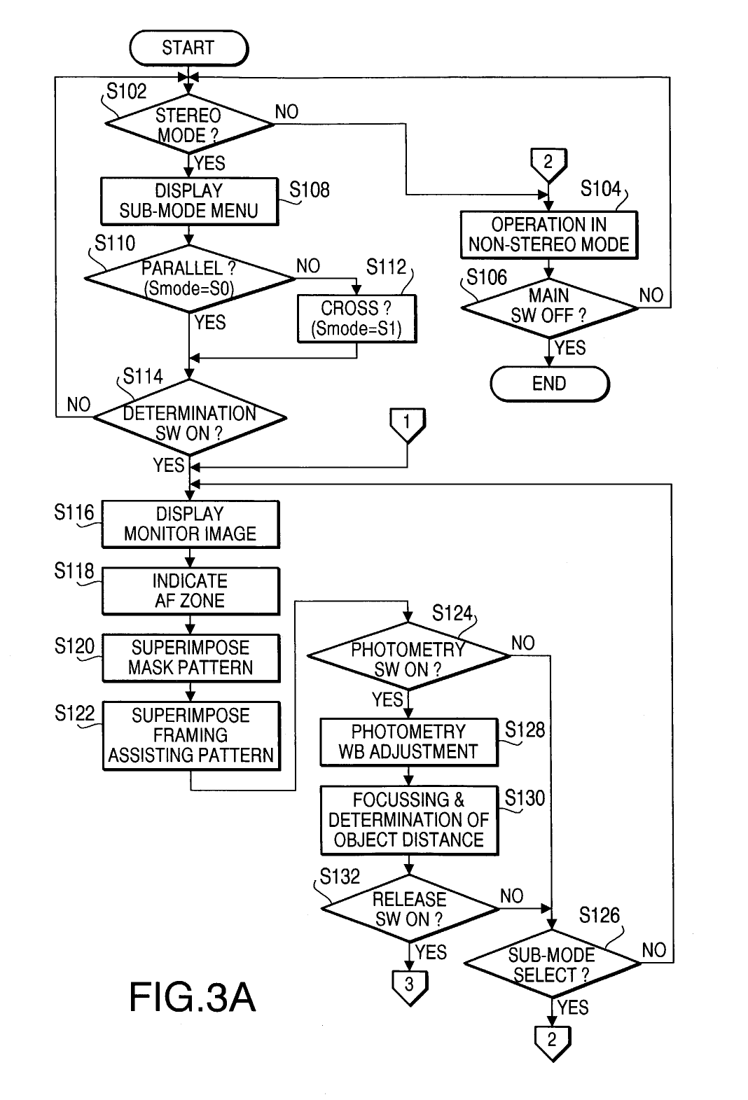

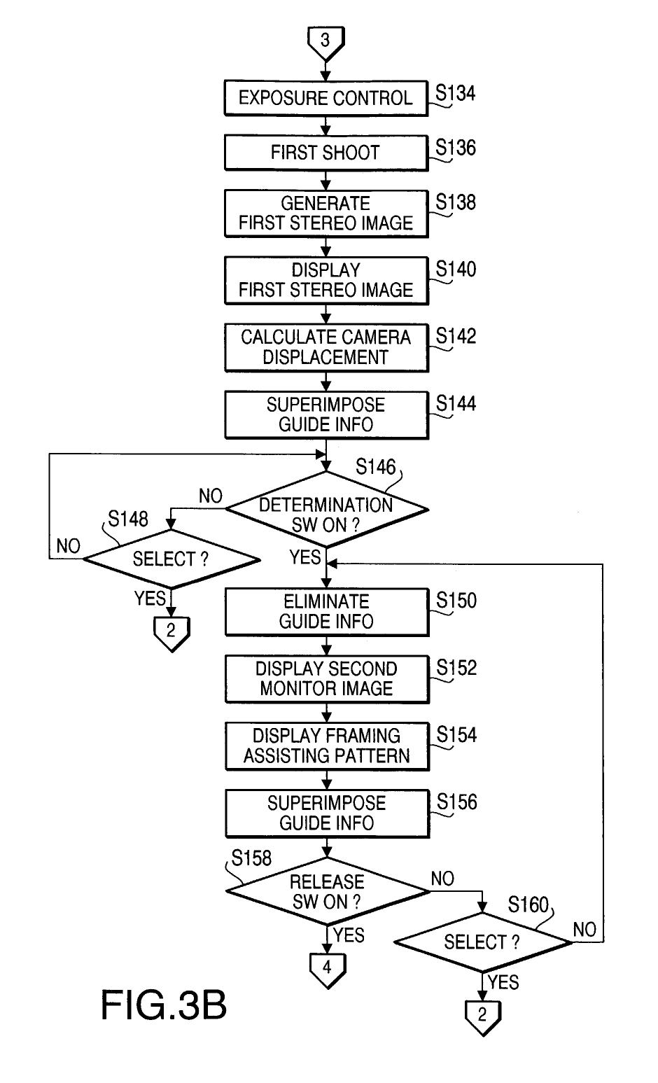

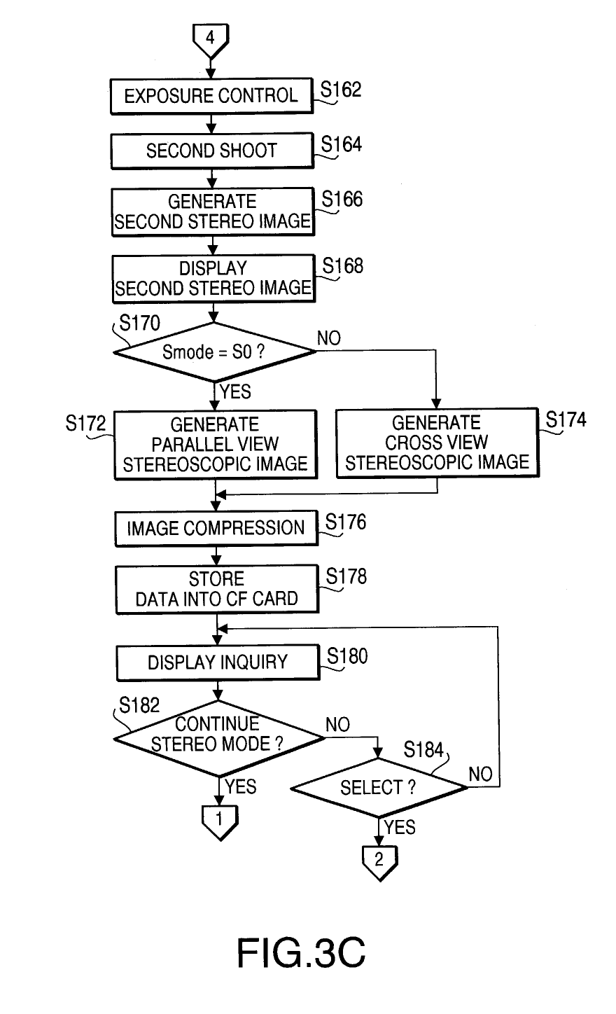

FIGS. 3A through 3C are flow charts showing a process carried out in the digital camera 10 according to the present embodiment when stereo mode is selected.

When the mode selecting dial 28 is set to recording mode and one of the sub-modes is selected, the digital camera 10 determines whether the stereo mode is currently selected or not (S102). If the stereo mode is not selected (S102:NO), the process proceeds to step S104 to operate the digital camera 10 in either the program AE mode or the manual mode, depending on the selection by the selecting switch 29. Then, it is determined whether the main switch 27 is OFF (S106). IF the main switch 27 is not OFF (S106:NO), the process returns to step S102, while the process terminates if the main switch 27 is OFF (S106:YES).

If the currently selected mode at step S102 is the stereo mode, a menu for selecting the stereo sub-mode, i.e., either the parallel view mode or the cross view mode, is superimposed on the LCD monitor 22 (S108). Note that the stereo sub-mode can be selected by operating the selecting switch 29.

Then, it is determined whether the parallel view mode is selected or not (S110). If the parallel view mode is currently selected (S110:YES), then “S0” is assigned to a variable Smode (S110), while “S1” is assigned to the variable Smode if the currently selected mode is the cross view mode (S110:NO, S112).

Next, it is determined whether the determination switch 30 is ON (S114). If it is not ON (S114:NO), the process returns to step S102 to repeat the steps S102 through S114 until the determination switch 30 is pressed.

If the determination switch 30 is ON at step S114, the process for capturing the first one of the stereoscopic pair of stills images, which will be referred to hereinafter as a first stereo image, will be carried out (steps S116 through S138). Note that, in the present embodiment, the first stereo image corresponds to the left image of the stereoscopic pair of images.

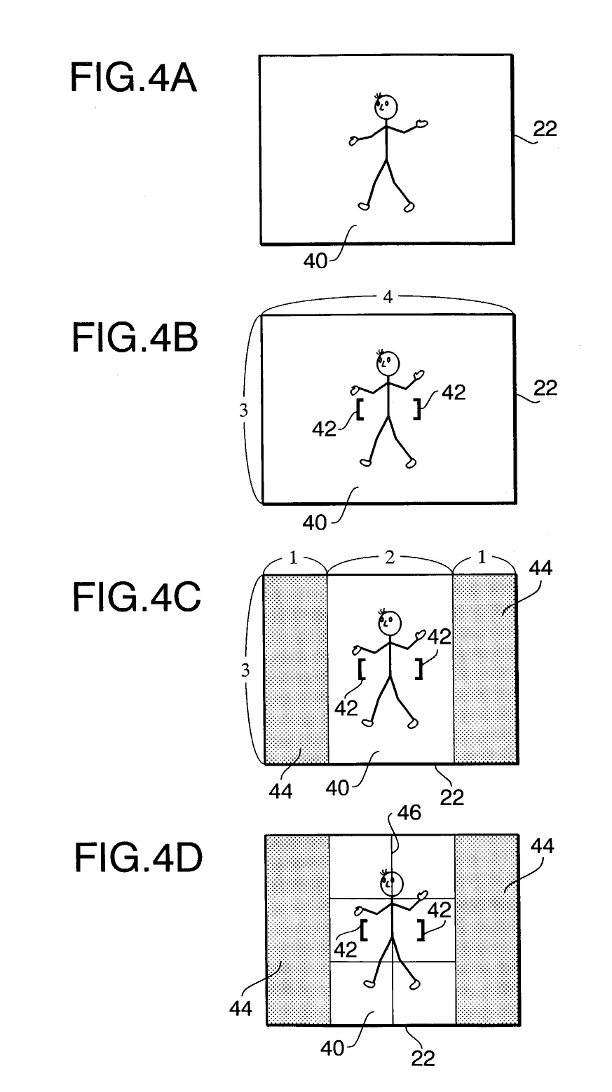

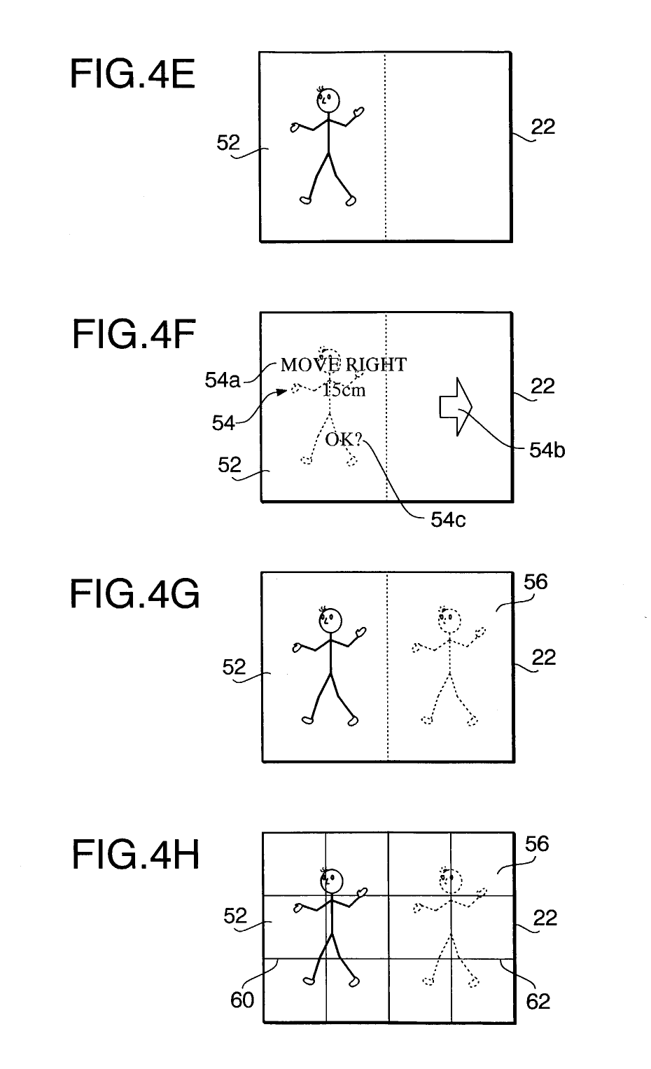

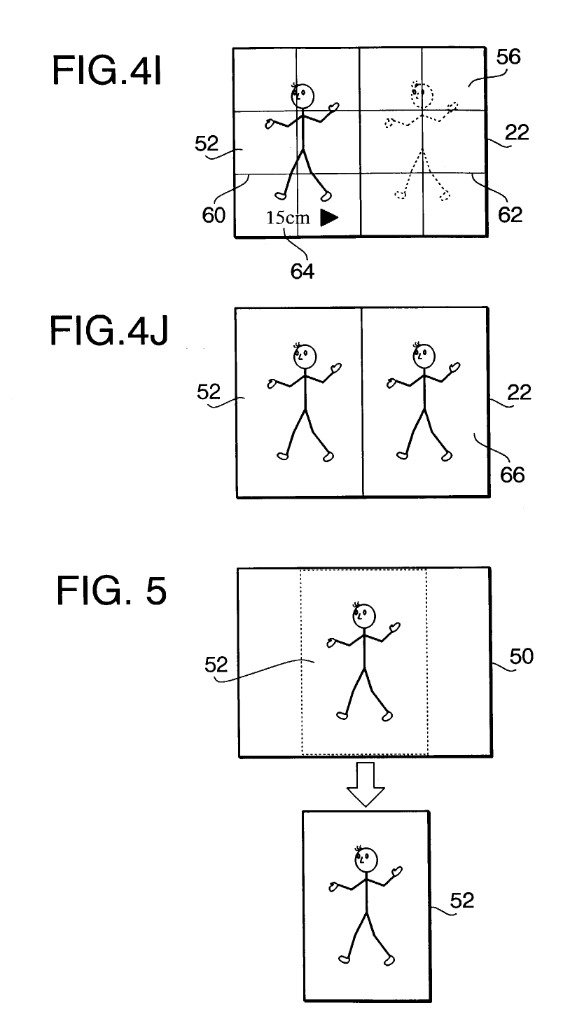

At step S116, the image currently captured by the CCD 12 is displayed on the LCD monitor 22, as shown in FIG. 4A, so as to allow the user to frame the object to be taken (this image will be referred hereinafter as first monitor image 40).

Next, a mark 42 such as “[]” is superimposed on the first monitor image 40 (S118), as shown in FIG. 4B. The mark 42 indicates an automatic focusing zone. That is, the digital camera 10 adjusts the focus of the lens system 11 such that the image of the object located within the mark 42 is sharply formed on the CCD 12.

As shown in FIG. 4B, the LCD monitor 22 has a landscape shape of which length to width ratio is three to four, for example. A normal picture taken by the digital camera 10 also has a landscape shape of which length to width ratio is three to four. Since the picture taken by the digital camera 10 in stereo mode includes a pair of stereo images, i.e., one stereo image on the left half of the picture and the other one stereo image on the right half, each of the stereo images has a portrait shape of which length to width ratio is three to two.

Since the length to width ratio differs between the LCD monitor 22 and the stereo image to be taken, it is difficult to correctly frame the stereo image if the first monitor image 40 is displayed on the LCD monitor 22 in full screen as shown in FIGS. 4A and 4B.

In order to solve the problem above, a mask pattern 44 is superimposed on the first monitor image 40 as shown in FIG. 4C (S120). The mask pattern 44 covers left and right side portions of the first monitor image 40 such that the first monitor image 40 appears only at a center area of which width is the half of the LCD monitor's width, and hence the length to width ratio of the first monitor image 40 becomes equal to that of the stereo image to be taken (i.e., three to two).

Next, a framing assisting pattern 46 is further superimposed on the first monitor image 40, as shown in FIG. 4D, to facilitate the framing of the image to be taken (S122). In the present embodiment, the framing assisting pattern 46 is a grid pattern having lines parallel to the top and bottom edges of the LCD monitor 22 and lines parallel to the side edges of the LCD monitor 22.

Next, it is determined whether the photometry switch 32 is ON (S124). If the photometry switch 32 is not ON (S124:NO), it is further determined whether the selecting switch 29 is ON (S126). If the selecting switch is not ON (S126:NO), then the process returns to step S116 to update the first monitor image 40 on the LCD monitor 22. Thus, the process for updating the first monitor image 40 displayed on the LCD monitor 22 (S116-S122) is repeated as long as the photometry switch 32 is not pressed and the currently selected sub-mode remains the stereo mode. Consequently, a moving image captured by the CCD 12 can be observed on the LCD monitor 22.

If, at step S126, the state of the selecting switch 29 is ON (S126:YES), which indicates either of the program AE mode or the manual mode is selected, the process jumps to step S104 to operate the digital camera 10 in the selected sub-mode.

If, at step S124, the photometry switch 32 is ON (S124:YES), which indicates the shutter button is depressed halfway, photometry and white balance adjustment is carries out based on the image signal from the CCD 12 (S128).

Next, at step S130, automatic focusing is performed. In the present embodiment, automatic focusing is performed by the contrast detection means which is well known in the art. That is, the focusing lens of the lens system 11 is moved to a position where optimum contrast is obtained in the image formed on the CCD 12 at an area thereof corresponding to the automatic focusing zone indicated by the mark 42 superimposed on the first monitor image 40.

Further, at step S130, the distance to the object is determined from the position of the focusing lens. The microprocessor 15 of the present embodiment includes a memory 15a in which an lookup table is stored. The lookup table provides the relation between the focusing lens position and the object distance. The microprocessor 15 determines the object distance from the position of the focusing lens by making reference to the lookup table. The position of the focusing lens is calculated based on the number of pulses provided to a pulse motor that is equipped to the focusing lens driving mechanism 23 for driving the focusing lens.

At step S132, it is determined whether the release switch 31 is ON. In other words, it is determined whether the shutter button of the digital camera 10 is fully depressed or not. If the release switch 31 is not ON (S132:No), the process proceeds to step S126. If the release switch is ON (S132:Yes), an automatic exposure control is carried out (S134).

Next, the first shoot is carried out (S136). That is, a full size still image, which will be referred to hereinafter as first full size image 50, is generated based on the output signal (image signal) of the CCD 12 and stored into the DRAM 16.

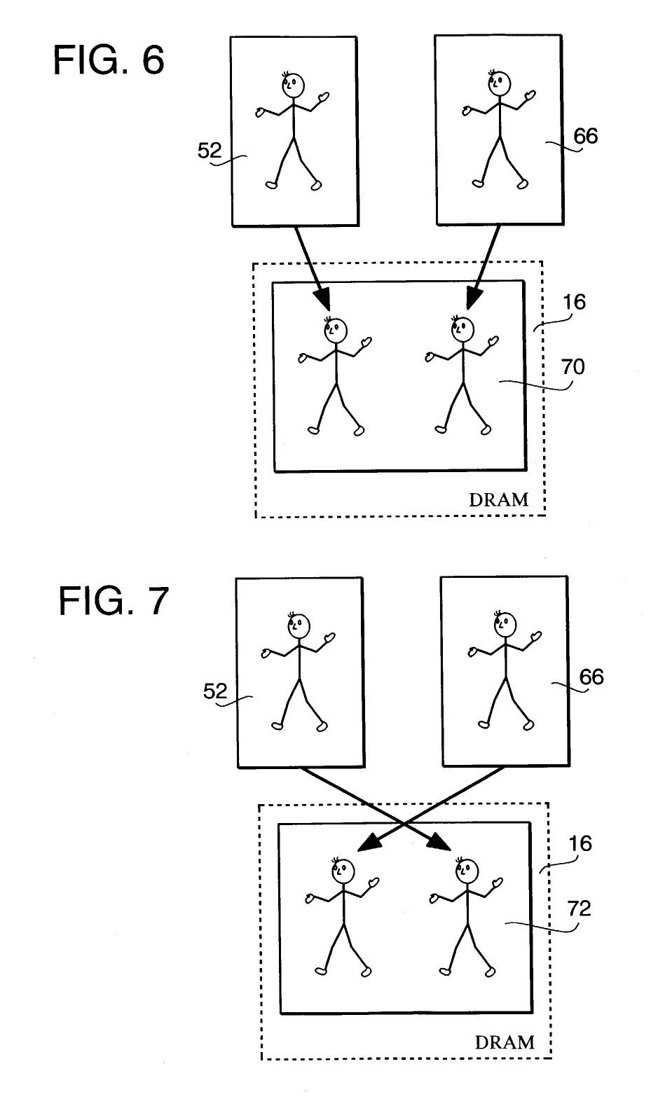

At step S138, the first stereo image is generated from the first full size image 50. As shown in FIG. 5, the first stereo image (indicated by reference number 52) is generated by extracting a part of the first full size image 50. The extracted part is the center area of the first full size image 50 and the width of the extracted part is the half of that of the first full size image 50.

Next, the first stereo image 52 is displayed on the LCD monitor 22 (S140). Since the first stereo image 52 corresponds to the left image of a stereoscopic pair of images, as mentioned before, the first stereo image 52 is displayed on the left half of the LCD monitor 22 as shown in FIG. 4E.

At step 142, the microprocessor 15 calculates the distance for which the digital camera 10 should be laterally moved after the first shoot in order to take the second one of the stereoscopic pair of still images, which will be referred to hereinafter as a second stereo image. The amount of the lateral camera displacement depends on the object distance that is obtained at step S130. Generally, a good stereoscopic effect can be obtained when the digital camera 10 is moved laterally for a distance within the range of 1/30 to 1/60 of the object distance. In the present embodiment, the amount of the camera displacement is determined to be 1/40 of the object distance, which is found to be most appropriate from experiences. For example, if the object distance is 6 m, the amount of the camera displacement is determined to be 15 cm.

Next, the mark 42, the mask pattern 44 and the framing assisting pattern 46 are eliminated from the LCD monitor 22, and a guide information 54 is superimposed on the LCD monitor 22, as shown in FIG. 4F, for advising the user the camera location suitable for the second shoot (S144). The guide information 54 includes, for example, text 54a indicating the direction and amount of the camera displacement, and an arrow 54b indicating the direction of the camera displacement. In the present embodiment, right direction is indicated by the text 54a and the arrow 54b since the second still image to be taken corresponds to the right image of the stereoscopic pair of images. Further, the guide information 54 includes text and/or a mark 54c that requires the user to depress the determination switch 30 to confirm that the user has seen the guide information 54. As shown in FIG. 4F, the guide information 54 is displayed in a size that substantially covers the whole LCD monitor 22.

At step S146, it is determined whether the determination switch 30 is ON. If the determination switch 30 is not ON (S146:NO), it is further determined whether the sub-mode selecting switch 29 is ON (S148). If the sub-mode selecting switch 29 is not ON (S148:NO), the process returns to step S146. If the sub-mode selecting switch 29 is ON (S148:YES), the process jumps to step S104.

If, at step S146, the determination switch is ON (S146:YES), which indicates that the user has seen the guide information 54 displayed on the LCD monitor 22 and depressed the determination switch 30, the process proceeds to step S150 to start the operation for shooting the second stereo image (steps S150-S164).

That is, at step 150, the guiding information 54 is removed from the LCD monitor 22.

Then, a second monitor image 56 is displayed on the right half of the LCD monitor 22, as shown in FIG. 4G, so as to allow the user to frame the digital camera 10 for the second shoot (S152). Namely, a center part of an image currently captured by the CCD 12 is extracted to get an image of half size in width direction, and displayed on the right half of the LCD monitor 22.

At step S154, framing assisting patterns 60 and 62 are superimposed on the first stereo image 52 and the second monitor image 56, respectively, as shown in FIG. 4H. A line thicker than the lines of the framing assisting patterns 60, 62 is also displayed on the boundary between the first stereo image 52 and the second monitor image 56.

The framing assisting patterns 60 and 62 have the same arrangement as that of the frame assisting pattern 46 superimposed on the first monitor image 40 at step S122. The framing assisting patterns 60 and 62 facilitates the framing of the digital camera 10 so as to locate the object in the second monitor image 56 at substantially the same location as that in the first stereo image 52.

At step S156, a guide information 64 is super imposed on the first stereo image 52 as shown in FIG. 4I. The guide information 64 includes text indicating the amount of camera displacement calculated at step S142 as well as a mark indicating the direction of displacement. Note that the guide information 64 is displayed in a small size so that it does not hinder the user from observing the first stereo image 52.

Next, it is determined whether the release switch 31 is ON (S158). In other words, it is determined whether the shutter button is fully depressed. If the release switch 31 is not ON (S158:NO), then it is determined whether the sub-mode selecting switch 29 is ON (S160). If the sub-mode selecting switch 29 is ON (S160:YES), the process jumps to step S104. The process, however, returns to step S150 to repeat the steps S150 through S156 if the sub-mode selecting switch 29 is not ON (S160:NO). In the later case, the monitor image displayed on right half of the LCD monitor 22 is updated by repeating the step S152 and thereby a moving image captured by the CCD 12 can be observed on the LCD monitor 22.

If, at step S158, the release switch 31 is ON (S158:YES), the exposure of the digital camera 100 is adjusted to the same condition as that of the first shoot (S162).

At step S164, the second shoot is carried out. That is, a full size still image, which will be referred to hereinafter as a second full size image, is generated based on the output signal (image signal) of the CCD 12 and stored into the DRAM 16. It should be noted that the shooting conditions (i.e. focusing distance, exposure condition, object distance, condition of white balance etc) is kept the same between the first and second shoots except for the location of the digital camera 10. Accordingly, the automatic focusing, for example, is not performed for the second shoot to keep the focusing lens of the lens system 11 at the position where it was at the time of the first shoot.

At step S166, the second stereo image is generated from the second full size image in a manner similar to generating the first stereo image 52. That is, the second stereo image is generated by extracting a center part of the second full size image of which width is half of the full size image.

The second stereo image corresponds to the right image of a stereoscopic pair of images. Accordingly, at step S168, the second stereo image obtained as above is displayed on the right half of the LCD monitor 22 as shown in FIG. 4J (see reference number 66).

Next, it is determined whether the variable Smode is “S0” (S170). In other words, it is determined whether the parallel view mode is currently selected. If the variable Smode is “S0” (S170:Yes), a set of data for a stereoscopic image 70 which is to be observed by parallel view method is generated from the first and second stereo images 52, 66 (S172), as schematically illustrated in FIG. 6, and stored into the DRAM 16. That is, an image is generated of which left half is the first stereo image 52 and the right half is the second stereo image 66.

If, at step S170, the variable Smode is not “S0”, a set of data for an stereoscopic image 72 which is to be observed by cross view method is generated from the first and second stereo images 52, 66, as schematically illustrated in FIG. 7, and stored into the DRAM 16 (S174). Namely, in the cross view stereoscopic image 72, the first stereo image 52 is located on the right half and the second stereo image 66 on the left half as shown in FIG. 7.

Next, the stereoscopic image 70 for parallel view method or the stereoscopic image 72 for cross view method is compressed (S176) and then stored into the CF card 26 (S178).

Next, an inquiry is displayed on the LCD monitor 22 asking the user whether to continue the stereo mode or not (S180). Then, it is determined whether the determining switch 30 is ON or depressed (S182). If the determining switch 30 is ON (S182:YES), the process returns to step S116 to take the next stereoscopic pair of images. If the determining switch 30 is not ON (S182:NO), then it is determined whether the selecting switch 29 is ON or not (S184). If the selecting switch 29 in not ON (S184:NO), then the process returns to step S180. If, however, the selecting switch 29 is ON (S184:YES), which indicates either the program AE mode or the manual mode is selected instead of the stereo mode, then the process jumps to step S104.

The process shown in FIGS. 3A through 3C terminates when the main switch 27 is turned off or when the mode selecting dial 28 is adjusted to a mode other than recording mode.

As described above, the digital camera according to the embodiment of the invention displays the guide information on the LCD monitor which includes the distance for which the camera should be laterally moved after the first stereo image is taken and thereby facilitates the user to locate the digital camera at a suitable location for taking the second stereo image.

The present disclosure relates to the subject matter contained in Japanese Patent Application No. P2002035090, filed on Feb. 13, 2002, which is expressly incorporated herein by reference in its entirety.

What is claimed is:

1. A camera for generating a stereoscopic pair of images by taking first and second images of an object in sequence, said camera comprising:
an object distance detector that detects an object distance, said object distance being a distance from said camera to the object at the time of taking said first image;
a displacing distance determiner that determines a distance for which said camera should be laterally displaced between first and second shoots for taking said first and second images, respectively, said distance being determined based on said object distance; and
a display unit that displays a guide information, said guide information including at least said distance for which said camera should be displaced.

2. The camera according to claim 1, wherein said guide information further includes a mark indicating the direction in which said camera should be displaced.

3. The camera according to claim 1, wherein said distance determiner determines said distance for which said camera should be displaced within a range of 1/30 to 1/60 of said object distance.

4. The camera according to claim 1, further comprising:
an optical system for forming an optical image of the object, said optical system having a focusing lens movable along an optical axis thereof; and
wherein said object distance detector detects said object distance based on the position of said focusing lens at the time when said optical system is focused on the object.

5. The camera according to claim 4, further comprising:
a memory, a lookup table being stored in said memory, said lookup table providing the relation between the position of said focusing lens and the object distance,
wherein said object distance detector determines said object distance by making reference to said lookup table.

6. The camera according to claim 1, wherein said display unit is also utilized to display an image currently captured by said camera for allowing framing of said first and second images.

7. The camera according to claim 1, further comprising:
a switch that is to be operated to confirm that a user has seen said guide information displayed by said display unit, and
wherein said display unit terminates displaying said guide information when said switch is operated.

8. A digital camera for generating a stereoscopic pair of images, said stereoscopic pair of images including a first image taken from a first camera location and a second image taken from a second camera location laterally displaced from said first camera location, said digital camera comprising:
an imaging device that captures said first and second images of the object; and
a display unit that displays the image currently captured by said imaging device to allow framing of the first and second images,
wherein said display unit further displays a guide information including the distance between said first and second camera locations.

9. The digital camera according to claim 8, wherein said guide information further includes a mark indicating the direction in which said digital camera should be moved after said first image is taken to be located at said second camera location.

10. The digital camera according to claim 8, wherein said guide information is displayed after a first shoot for taking said first image and before a second shoot for taking said second image.

11. The digital camera according to claim 8, further comprising a processor that determines the distance between said first and second camera locations based on an object distance at the time of taking said first image.

12. The digital camera according to claim 11, further comprising:
a lens system that forms an optical image of the object on said imaging device, said lens system including a focusing lens movable along an optical axis thereof,
wherein said processor determines said object distance from the position of said focusing lens along said optical axis at the time of taking said first image.

13. The digital camera according to claim 12, further comprising:
a memory, a lookup table being stored in said memory, said lookup table providing the relation between the focusing lens position and the object distance,
wherein said processor determines said object distance by making reference to said lookup table.

14. The camera system according to claim 8, further comprising:
a switch that is to be operated to confirm that a user has seen said guide information displayed by said display unit, and
wherein said display unit terminates displaying said guide information when said switch is operated.
